(19) United States
(12) Patent Application Publication
(10) Pub. No.: US 2022/0366318 A1
(43) Pub. Date: Nov. 17, 2022

(54) Machine Learning Hyperparameter Tuning

(71) Applicant: Google LLC, Mountain View, CA (US)

(72) Inventors: Jiaxun Wu, Mountain View, CA (US); Ye Zichaun, Mountain View, CA (US); Mingge Deng, Kirkland, WA (US); Amir Hormati, Mountain View, CA (US)

(73) Assignee: Google LLC, Mountain View, CA (US)

(21) Appl. No.: 17/663,430

(22) Filed: May 15, 2022

Related U.S. Application Data
(60) Provisional application No. 63/189,496, filed on May 17, 2021.

(51) Int. Cl. G06N 20/20; G06F 16/242; G06F 16/27

(52) U.S. Cl. CPC G06N 20/20; G06F 16/2445; G06F 16/27

(57) ABSTRACT

A method, when executed by data processing hardware, causes the data processing hardware to perform operations including receiving, from a user device, a hyperparameter optimization request requesting optimization of one or more hyperparameters of a machine learning model. The operations include obtaining training data for training the machine learning model and determining a set of hyperparameter permutations of the one or more hyperparameters. For each respective hyperparameter permutation in the set of hyperparameter permutations, the operations include training a unique machine learning model using the training data and the respective hyperparameter permutation and determining a performance of the trained model. The operations include selecting, based on the performance of each of the trained unique machine learning models of the user device, one of the trained unique machine learning models. The operations include generating one or more predictions using the selected one of the trained unique machine learning models.

### CROSS REFERENCE TO RELATED APPLICATIONS

This U.S. patent application is a continuation of, and claims priority under 35 U.S.C. § 119(e) to U.S. Provisional Application 63/189,496, filed on May 17, 2021. The disclosure of this prior application is considered part of the disclosure of this application and is hereby incorporated by reference in its entirety.

### TECHNICAL FIELD

This disclosure relates to machine learning hyperparameter tuning

### BACKGROUND

Machine learning hyperparameters are values used to control the learning process of a machine learning model. For example, machine learning hyperparameters include a topology of the model, a size of the model, and a learning rate of the model. Because hyperparameters cannot be inferred while fitting the model to training data, hyperparameter tuning is conventionally a manual trial and error endeavor. Thus, in conventional machine learning models, a significant portion of time and resources may be required to perform sophisticated, manual, and laborious studies aimed to search or determine optimal hyperparameters.

### SUMMARY

One aspect of the disclosure provides a computer-implemented method for performing machine learning hyperparameter tuning that, when executed by data processing hardware, causes the data processing hardware to perform operations. The operations include receiving, from a user device, a hyperparameter optimization request requesting optimization of one or more hyperparameters of a machine learning model. The operations also include obtaining training data for training the machine learning model and determining a set of hyperparameter permutations of one or more hyperparameters of the machine learning model. For each respective hyperparameter permutation in the set of hyperparameter permutations, the operations include training a unique machine learning model using the training data and the respective hyperparameter permutation and determining a performance of the trained unique machine learning model. The operations also include selecting, based on the performance of each of the trained unique machine learning models, one of the trained unique machine learning models. The operations include generating one or more predictions using the selected one of the trained unique machine learning models.

Implementations of the disclosure may include one or more of the following optional features. In some implementations, the operations include determining the set of by per parameter permutations includes performing a search on a hyperparameter search space of the one or more hyperparameters of the machine learning model. In some of these implementations, the operations include performing the search using a batched Gaussian process bandit optimization. Optionally, the operations include determining the set of hyperparameter permutations based on one or more previously trained machine learning models that each shares at least one hyperparameter with the one or more hyperparameters of the machine learning model. The one or more previously trained machine learning models may be associated with a user of the user device.

In some examples, training the unique machine learning model includes training two or more unique machine learning models in parallel. Optionally, providing the performance of each of the trained unique machine learning models to the user device includes providing, to the user device, an indication indicating which trained unique machine learning model has the best performance based on the training data. The hyperparameter optimization request may include an SQL query. Optionally, the hyper parameter optimization request includes a budget and a size of the hyperparameter permutations of the one or more hyperparameters of the machine learning model is based on the budget. In some examples, the data processing hardware is part of a distributed computing database system. In another implementation, selecting one of the trained unique machine learning models includes transmitting the performance of each of the trained unique machine learning models to the user device and receiving, from the user device, a trained unique machine learning model selection selecting one of the trained unique machine learning models.

Another aspect of the disclosure provides a system for performing machine learning hyperparameter tuning. The system includes data processing hardware and memory hardware in communication with the data processing hardware. The memory hardware stores instructions that, when executed on the data processing hardware, cause the data processing hardware to perform operations. The operations include receiving, from a user device, a hyperparameter optimization request requesting optimization of one or more hyperparameters of a machine learning model. The operations also include obtaining training data for training the machine learning model and determining a set of by per parameter permutations of one or more hyperparameters of the machine learning model. For each respective hyperparameter permutation in the set of hyperparameter permutations, the operations include training a unique machine learning model using the training data and the respective hyperparameter permutation and determining a performance of the trained unique machine learning model. The operations also include selecting, based on the performance of each of the trained unique machine learning models, one of the trained unique machine learning models. The operations include generating one or more predictions using the selected one of the trained unique machine learning models.

This aspect may include one or more of the following optional features. In some implementations, the operations include determining the set of hyperparameter permutations includes performing a search on a hyperparameter search space of the one or more hyperparameters of the machine learning model. In some of these implementations, the operations include performing the search using a batched Gaussian process bandit optimization. Optionally, the operations include determining the set of hyperparameter permutations based on one or more previously trained machine learning models that each shares at least one hyperparameter with the one or more hyperparameters of the machine learning model. The one or more previously trained machine learning models may be associated with a user of the user device.

In some examples, training the unique machine learning model includes training two or more unique machine learning models in parallel. Optionally, providing the performance of each of the trained unique machine learning models to the user device includes providing, to the user device, an indication indicating which trained unique machine learning model has the best performance based on the training data. The hyperparameter optimization request may include an SQL query. Optionally, the hyperparameter optimization request includes a budget and a size of the hyperparameter permutations of the one or more hyper parameters of the machine learning model is based on the budget. In some examples, the data processing hardware is part of a distributed computing database system. In another implementation, selecting one of the trained unique machine learning models includes transmitting the performance of each of the trained unique machine learning models to the user device and receiving, from the user device, a trained unique machine learning model selection selecting one of the trained unique machine learning models.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for machine learning hyperparameter tuning.

FIG. 2 is a schematic view of components of a hyperparameter controller for searching a hyperparameter search space.

FIG. 3A is a schematic view of a hyperparameter controller receiving an increased budget for a permutation controller.

FIG. 3B is a schematic view of the hyperparameter controller of FIG. 3A receiving a decreased budget for the permutation controller.

FIG 4 is a flowchart of an example arrangement of operations of a method of performing machine learning hyperparameter tuning.

FIG. 5 is a schematic view of an example computing device that may be used to implement the systems and methods described herein.

Like reference symbols in the various drawings indicate like elements.

### DETAILED DESCRIPTION

Machine learning hyperparameters are values used to control the learning process of a machine learning model. For example, machine learning hyperparameters include a topology of the model, a size of the model, and a learning rate of the model. Because hyperparameters cannot be inferred while fitting the model to training data, hyperparameter tuning is conventionally a manual trial and error endeavor. Thus, in conventional machine learning models, a significant portion of time and resources may be required determine and/or search for optimal hyperparameters. Thus, it is advantageous to incorporate a controller that can fully or partially automate the hyperparameter tuning (i.e., reduce or eliminate manual tuning) and training of machine learning models, which may further optimize efficiency by leveraging a cloud computing system.

Implementations herein include a hyperparameter controller that implements automatic hyperparameter tuning among distributed computing systems (e.g., cloud database systems). The controller may implement a Structured Query Language (SQL)-based interface that allows a user to automate hyperparameter tuning within the cloud computing system, and the search algorithms may automatically search for the optimal hyperparameters for training the machine learning models. For example the controller may include a search space for automatic hyperparameter searching for use during training of the machine learning models.

In addition, the controller may collect and apply previously trained models to execute training of future models. This maximizes the efficiency of the system by utilizing previously stored information to update and train new models within the system. The automated process of searching and applying optimized hyperparameters maximizes the efficiency for the users, such that the users are free from conducting manual searching and comparisons on an individual model level. The system is capable of training multiple models in a single iteration (i.e., in parallel) to greatly reduce training time. The system may provide the user with a performance of each trained model and, in some examples, select the best model from each of the models trained automatically.

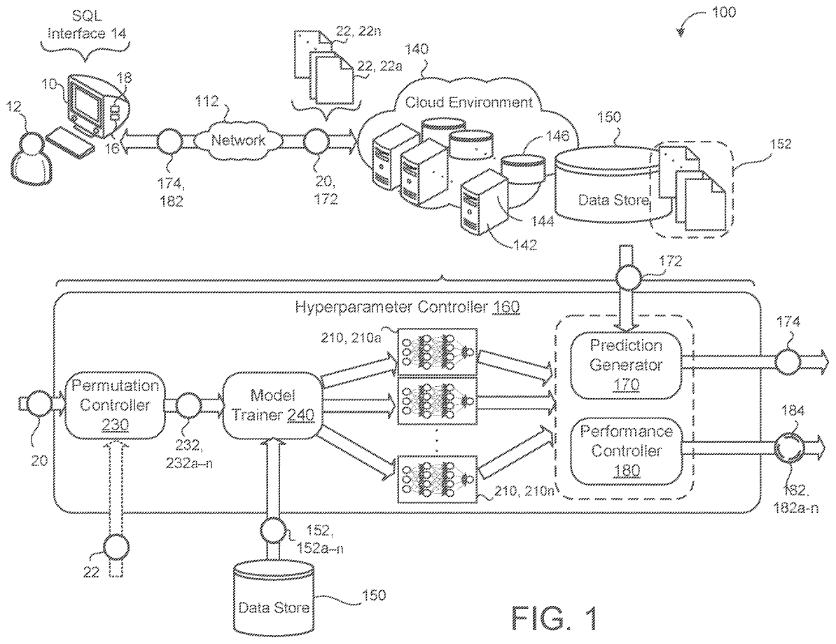

Referring now to FIG. 1, in some implementations, an example hyperparameter tuning system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store training data 152 (e.g., within a cloud database). The training data 152 may be associated with or controlled by a user 12.

The remote system 140 is configured to receive a hyperparameter optimization request 20 from the user device 10 associated with the respective user 12 via, for example, the network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g. memory hardware). The user 12 may construct the request 20 using a Structured Query Language (SQL) interface 14. That is, the user 12 may generate the hyperparameter optimization request 20 using an SQL query. Each hyperparameter optimization request 20 requests the remote system 140 to optimize one or more hyperparameters 22, 22a-n of a machine learning model 210.

The remote system 140 executes a hyperparameter controller 160 that receives the request 20 requesting the hyperparameter controller 160 to optimize one or more hyperparameters 22 of the machine learning model 210 and train the model 210 using the optimized hyperparameters 22. Each hyperparameter 22 for the hyperparameter controller 160 to tune has multiple possible values that may be used for training the machine learning model 210. Certain possible values of these hyperparameters 22 are more optimal (e.g., lead to a faster or more efficient training process) than other possible hyperparameter values 22.

The hyperparameter controller 160 includes a permutation controller 230 that receives the request 20 and obtains the hyperparameters 22. The request may identify some or all of the hyperparameters 22 for tuning. Additionally or alternatively, the permutation controller 230 obtains one or more default hyperparameters 22 not identified by the request 20. The permutation controller 230 generates or determines a set of hyperparameter permutations 232, 232a-n based on the hyperparameters 22. Each hyperparameter permutation 232 includes different values for at least one of the hyperparameters 22. Using a simplified example for clarity, when the permutation controller 230 receives three hyperparameters 22 that each have possible values of 1, 2, or 3, the permutation controller 230 may generate a first hyperparameter permutation 232 with values {1, 1, 1}, a second hyperparameter permutation 232 with values {1, 1, 2}, a third hyperparameter permutation 232 with values {1, 1, 3}, a fourth hyperparameter permutation 232 with values {1, 2, 1}, etc. The set of hyperparameter permutations 232 include some or all of the different combination of potential values for the hyperparameters 22 of the machine learning model 210.

The permutation controller 230 may determine the sets of hyperparameter permutations 232 (i.e., tune the hyperparameters 22) using one or more tuning algorithms. One or more of the tuning algorithms may be default and/or selected by the user 12 (e.g., via the request 20). The tuning algorithms may be used to tune (i.e., adjust the values of) the hyperparameters 22, 22a-n used for training machine learning models 210. In some implementations, the permutation controller 230 determines whether a hyperparameter 22 is valid or invalid. When the permutation controller 230 determines that a hyperparameter 22 is invalid (e.g., invalid values, incompatible with other hyperparameters 22 or models 210, etc.), then the permutation controller 230 may discard or otherwise not use the hyperparameter permutation 232 including the invalid hyperparameter 22.

In some examples, the request 20 includes a number of hyperparameter permutation 232 to generate (or a number of machine learning models 210 to train, as discussed in more detail below). That is, die request may include a training budget. The permutation controller 230 may stop generating hyperparameter permutations 232 when the budget is reached. For example, the request 20 indicates that the user 12 desires the maximum number of hyperparameter permutations 232 to generate is one hundred.

The hyperparameter controller 160 also includes a model trainer 240. The model trainer 240 obtains the training data 152 for training the machine learning model 210. The model trainer 240 may retrieve the training data 152 from, for example, the data store 150. In other examples, the request 20 includes the training data 152. The training data 152 may include any type of data that the machine learning model 210 is trained to receive (e.g., text, images, audio, etc.). For example, the training data 152 includes data from a database and the machine learning model 210 is trained to predict future values based on values from the database. The model trainer 240 also receives the set of the hyperparameter permutations 232 (i.e., the different combinations of different values for each of the hyperparameters 22).

For each respective hyperparameter permutation 232 in the set of hyperparameter permutations 232, the model trainer 240 may train a unique machine learning model 210, 210a-n using the training data 152 and the respective hyperparameter permutation 232. For example, when there are fifty different hyperparameter permutations 232, the model trainer 240 trains fifty different machine learning models 210 (i.e., one for each of the fifty different hyperparameter permutations 232). In some examples, the request 20 limits or restricts the number of models 210 trained to a number that is less than the total number of hyperparameter permutations 232. Each machine learning model 210 may be trained using the same training data 152 using the hyperparameters 22 dictated by the corresponding hyperparameter permutation 232. That is, each machine learning model 210 is trained using the same training data 152 but different values for the hyperparameters 22. The model trainer 240 may train two or more of the machine learning models 210 in parallel (i.e., simultaneously), as described in more detail below. Alternatively, the model trainer 240 may train the models 210 in series.

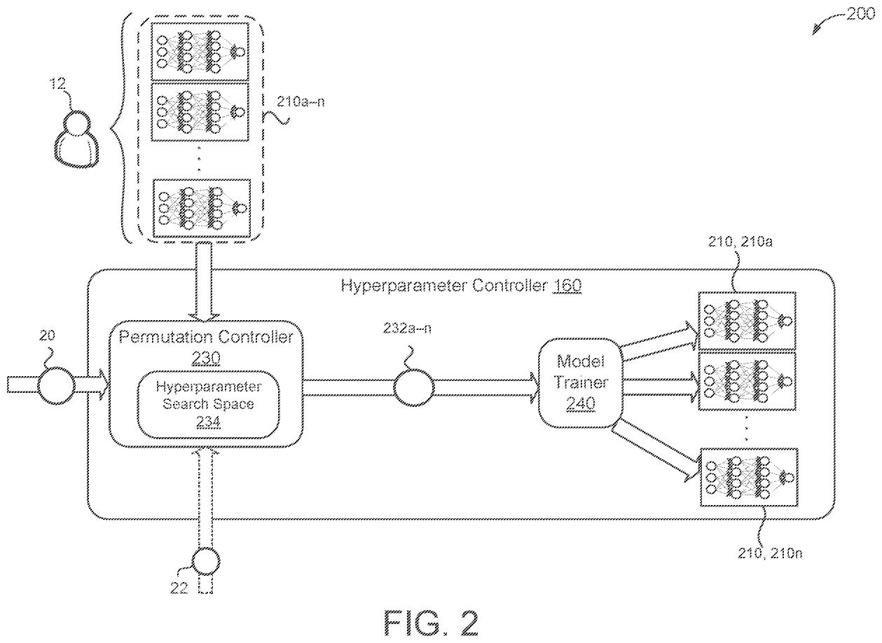

Referring now to FIG. 2. the permutation controller 230 of the hyperparameter controller 160 determines the sets of hyperparameter permutations 232 from a hyperparameter search space 234 (i.e., by searching the hyperparameter search space 234). The hyperparameter search space 234 represents the feasible region defining the set of all possible solutions for hyperparameter 22 tuning. For example, with ten hyperparameters 22 with each having one hundred possible values, the hyperparameter search space 234 includes a total of 100¹⁰ possible solutions. It is readily apparent that as the number of hyperparameters 22 grows, the hyperparameter search space 234 quickly grows to unfathomable sizes. Thus, the permutation controller 230 may attempt to intelligently or efficiently “reduce” the hyperparameter search space 234 by discarding known poor portions and/or focusing on known effective portions.

In some implementations, the permutation controller 230 determines the set of hyperparameter permutations 232 at least in part based on models 210 previously trained by the model trainer 240. As shown by schematic view 200, the permutation controller 230 determines one or more models 210 the model trainer 240 has previously trained for the user 12 (e.g., via a profile or identification of the user 12) and/or the user 12 selects or provides one or more of the previously trained models 210 (e.g., via the request 20) in these implementations, the previously trained model(s) 210 are associated with the user 12 of the user device 10. In other examples, the permutation controller 230 selects previously trained models 210 with training data 152 similar to the current training data Regardless of the source, the permutation controller 230 may determine the hyperparameter permutations 232 using the hyperparameters 22 selected for the previously trained models 210 as a guide. For example, the permutation controller 230 determines the set of hyperparameter permutations 232 based on one or more previously trained machine learning models 210 that each share at least one hyperparameter 22 with the hyperparameters 22 of the current machine learning model 210 and/or request 20. The permutation controller 230 may use the hyperparameters 22 of the previously trained machine learning models 210 to reduce the hyperparameter search space 234 by freezing or limiting the values of hyperparameters 22 that align with hyperparameters of the previously trained machine learning models 210. The permutation controller 230 may retrieve the hyperparameters from the data store 150. Similarly, once training the machine learning models 210 is complete, the hyperparameters 22 of one or more of the trained models may be stored within a hyperparameter table or other data structure at the data store 150. The table may be updated as the model trainer 240 trains new machine learning models 210.

In some implementations, the permutation controller 230 uses transferred learning to improve the selection of hyperparameters 22. In these implementations, the permutation controller 230 leverages data from the previously trained machine learning models 210 (i.e., trained before receiving the current optimization request 20) associated with the user 12, that include at least a subset of the same hyperparameters 22 to improve the searching for optimal hyperparameters 22. Transferred learning may help avoid a “cold start” where the initial batch of hyperparameters 22 is selected via random exploration. As discussed above, the previously trained machine learning models 210 may be associated with the same user 12 that provided the current optimization request 20. In other examples, the previously trained machine learning models 210 are not associated with the same user 12.

In some implementations, the permutation controller 230 uses an algorithm that automatically finds or searches for optimal hyperparameters 22 within the hyperparameter search space 234 (e.g., based on Gaussian process bandits, covariance matrix adaptation evolution strategy, random search, grid search, etc.).

In some examples, the user 12 provides limits to the hyperparameter search space 234 via the request 20. For example, the request 20 may include limits on values of one or more hyperparameters 22 or restrict the permutation controller 230 to specific algorithms. When the request 20 does not provide such restrictions, the permutation controller 230 may apply one or more default restrictions to the hyperparameter search space 234. Additionally or alternatively, the permutation controller 230 supports conditional hyperparameters 22 that are only applicable given when specific conditions are met.

In some examples, the permutation controller 230 initiates hyperparameter tuning by solving a black-box optimization problem, i.e., to find X* which optimizes the “black-box” function objective f: X->R. With “black-box” being said, one can only observe the function output given the input finite times with relative expensive cost, and cannot access other information of the function f, such as its Gradient and Hessian, etc. In some implementations, the controller uses Gaussian Process Bandits as a default algorithm to solve the above black-box optimization problem, although other algorithms may also be the default (e.g., covariance matrix adaptation evaluation strategy, random search, grid search, etc.). The request 20 may override the default algorithm by specifying a specific algorithm and/or providing an external algorithm. When the function f is modelled as a parameterized Gaussian process of x, or, more specifically f(x)˜GP(u(x), k(x,x′)) with mean u(x) and covariance k(x, x′), the controller may solve using Gaussian Process Regression fitting.

In some examples, given historical observation pairs: (x_1, f(x_1)), (x_2, f(x_2)), . . . , (x_t), f(x_t)), the permutation controller 230 fits and/or updates the Parameterized Gaussian Process Model (Gaussian Process Regressor) with the historical observations. The permutation controller 230 may suggest x_t+1 using Bayesian Sampling Procedure and explore/exploit balance strategy for multi-armed bandit problem (i.e., x) which maximizes both the mean and variance of modelled f(x) will be chosen as x_t+1 with the biggest probability.

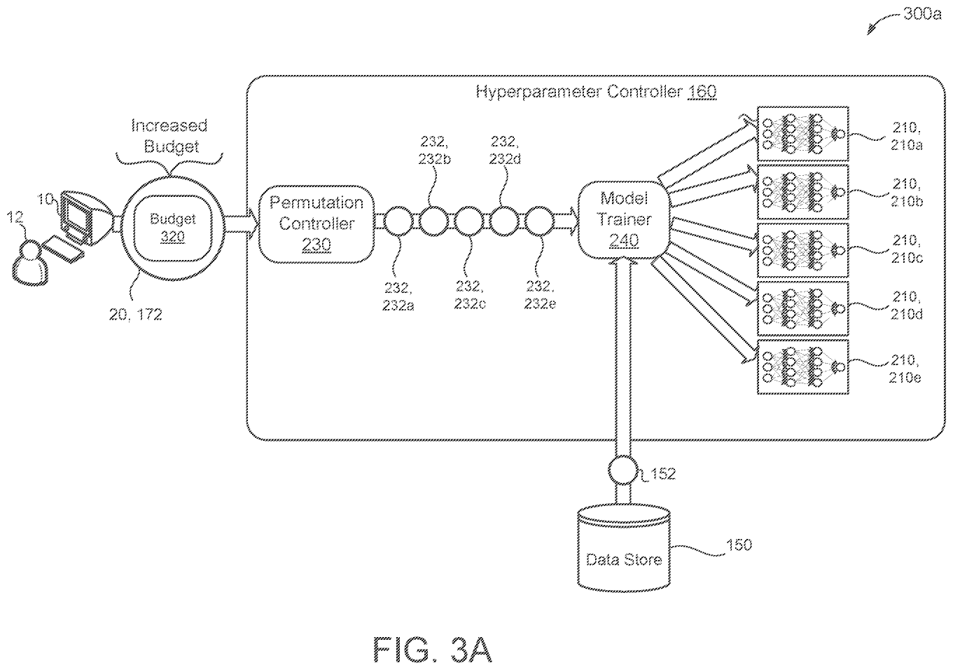

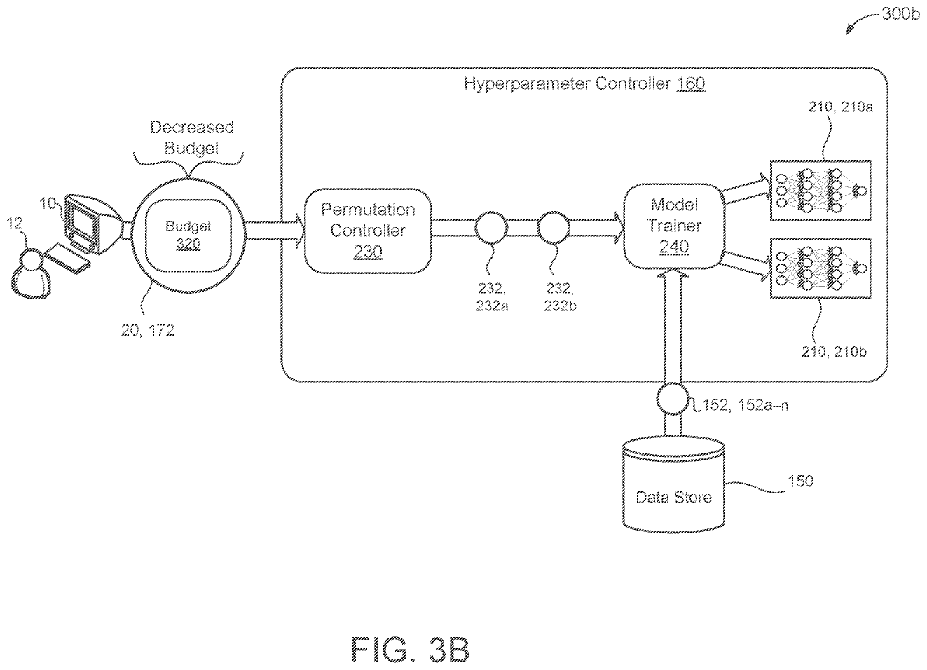

Referring now to FIGS. 3A and 3B, the user may configure or specify or request the total number of models 210 trained (and the number of models 210 trained in parallel) based on a budget 320 provided via, for example, the request 20 The budget 320 may correspond to a number of trials the user 12 is requesting to have executed, a monetary value associated with a cost of operating or utilizing the remote system 140, a number of models 210 the user 12 elects to have trained: and/or other aspects for which the user 12 may have set parameters. For example, as depicted in FIG. 3A, the user 12 sets an increased budget 320, which results in the permutation controller 230 generating five hyperparameter permutations 232, 232a-e. The number of hyperparameter permutations 232, in this example, directly corresponds to the number of models 210 the model trainer 240 trains. Schematic view 300a includes the model trainer 240 training five models 210, 210a-e corresponding with the five hyperparameter permutations 232, 232a-e received from the permutation controller 230 Continuing the example of FIG. 3A, schematic view 300b (FIG. 3B) illustrates the user 12 decreasing the budget 320, such that fewer models 210 are trained. Here, the decreased budget 320 results in two hyperparameter permutations 232a, 232b generated by the permutation controller 230. As a result, the model trainer 240 trains two models 210a, 210b. The budget 320 may be adjusted depending, on the computational parameters of the user 12, such that more than five models 210, 210a-n may be trained using more than five permutations 232, 232a-n and/or a single model 210 may be trained using a single hyperparameter permutation 232. These are simplified examples, and the remote system may generate hundreds, thousands, or even millions of different hyperparameter permutations 232.

The number of models 210 trained by the model trainer 240 may have a direct relationship to the number of hyperparameter permutations 232 from the permutation controller 230. The budget 320 may thus dictate the number of models 210 that are trained by dictating the number of hyperparameter permutations 232 determined by the permutation controller 230. Stated differently, the user 12 may adjust the number of models 210 generated by adjusting the size of the budget 320. Additionally or alternatively, the budget 320 may be used to determine an amount of searching the hyperparameter search space 234 (e.g., a time duration, an amount of resources to spend, etc.), such that a default amount of searching of the hyperparameter search space 234 may be selected based on the budget 320. For example, the hyperparameter controller 160 tunes the hyperparameters 22 based on a priority order of the models 210 within the allotted budget 320.

Referring back to FIG. 1, once the model trainer 240 trains the models 210, a performance controller 180 determines a respective performance 182, 182a-n of each of the trained models 210. For example, the performance controller 180 uses some or all of the training data 152 to measure an accuracy of each model 210 by comparing labels or annotations of training samples with predictions generated by each model 210. The performance controller 180 provides the determined performance 182 to the user device 10. The hyperparameter controller 160 may send other attributes of the models 210 along with the performance 182 (e.g., a size of the models 210). The user 12 may select one or more of the trained models 210 based on the provided performance 182 and/or the other attributes. In some examples, the hyperparameter controller 160 automatically selects a mode) 210 (e.g., the model 210 with the highest performance 182 or a model 210 that meets default or other pre-selected criteria). In these examples, the hyperparameter controller 160 may provide an indication to the user 12 of which model 210 was selected. In some implementations, in addition to the performance 182, the performance controller 180 provides (i.e., by transmitting via the network 112) an indication 184 of which trained model 210 has the best performance 182 based on the training data 152. The user 12 may further decide which of the trained models 210 to select based on the indication 184, and any other attributes provided by the hyperparameter controller 160.

The user 12 may select one of the trained machine learning models 210 by sending a trained model selection 172 to a prediction generator 170 of the hyperparameter controller 160. In other examples, the performance controller 180 sends the trained model selection 172 to the prediction generator 170. The prediction generator 170 generates a prediction 174 based on the model selection 172 received from the user device 10. For example, the prediction generator 170 receives additional data (e.g., via the data store 150 or via the user device 10) and the selected model 210 makes one or more predictions based on the additional data The prediction 174 may be provided to the user device 10. Alternatively, the hyperparameter controller 160 may bypass the user device and simply generate the trained model selection 17 selecting the one of the trained unique models 210 having the best performance 182 directly, and then provide the trained model selection 172 directly to the prediction generator 170 for generating the prediction 174.

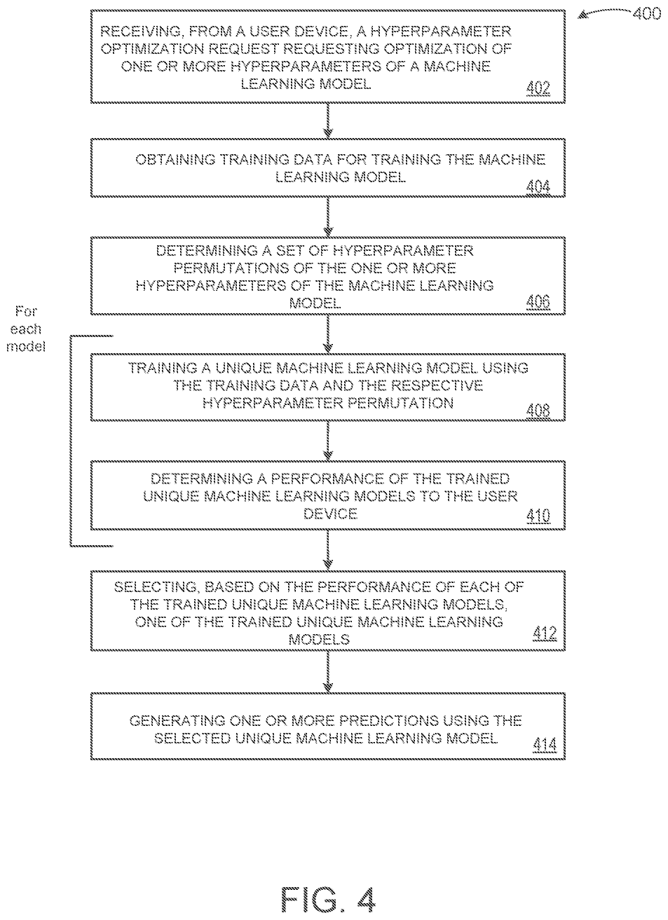

FIG. 4 is a flowchart of an exemplary arrangement of operations for a method 400 of tuning hyperparameters 22. The computer-implemented method 400, when executed by data processing hardware 144, causes the data processing hardware 144 to perform operations. The method 400, at operation 402, includes receiving, from a user device 10, a hyperparameter optimization request 20. The hyperparameter optimization request 20 requests optimization of one or more hyperparameters 22 of a machine learning model 210. The method 400, at operation 404, includes obtaining training data 152 for training the machine learning model 210. The method 400, at operation 406, includes determining a set of hyperparameter permutations 232 of the machine learning model 210. The method 400, at operation 408, includes training a unique machine learning model 210 using the training data 152 and the respective hyperparameter permutation 232. The method 400, at operation 410, includes determining a performance 182 of the trained unique machine learning model 210 The method 400, at operation 412, includes selecting, based on the performance 182 of each of the trained unique machine learning models 210, one of the trained unique machine learning models 210. At operation 414. the method 400 includes generating one or more predictions 174 using the selected one of the trained unique machine learning models 210.

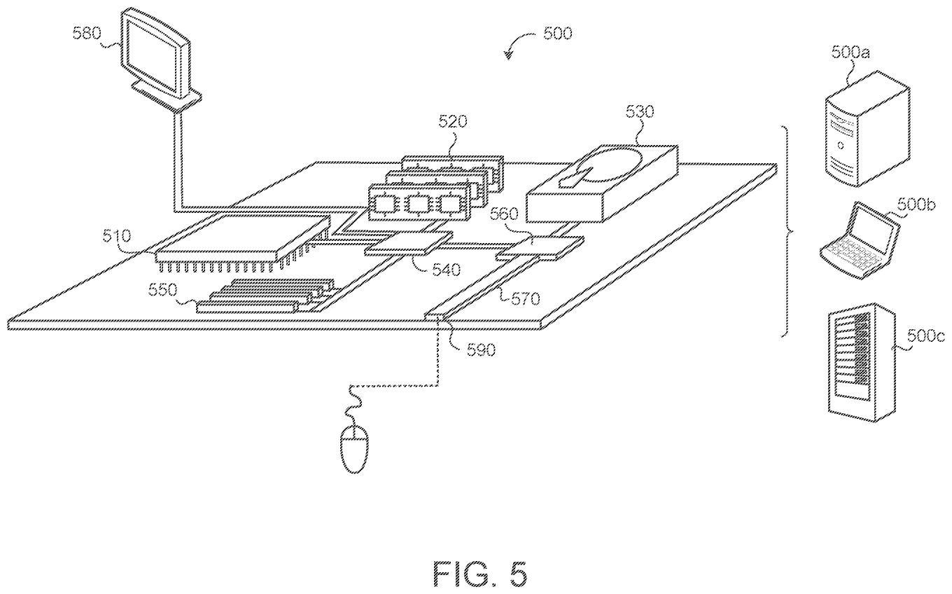

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the disclosures described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth. Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware that causes the data processing hardware to perform operations comprising:
receiving, from a user device, a hyperparameter optimization request requesting optimization of one or more hyperparameters of a machine learning model;
obtaining training data for training the machine learning model;
determining a set of hyperparameter permutations of the one or more hyperparameters of the machine learning model;
for each respective hyperparameter permutation in the set of hyperparameter permutations:
training a unique machine learning model using the training data and the respective hyperparameter permutation; and
determining a performance of the trained unique machine learning model;
selecting, based on the performance of each of the trained unique machine learning models, one of the trained unique machine learning models; and
generating one or more predictions using the selected one of the trained unique machine learning models.

2. The method of claim 1, wherein determining the set of hyperparameter permutations comprises performing a search on a hyperparameter search space of the one or more hyperparameters of the machine learning model.

3. The method of claim 2, wherein performing the search on the hyperparameter search space comprises performing the search using a batched Gaussian process bandit optimization.

4. The method of claim 1, wherein determining the set of hyperparameter permutations is based on one or more previously trained machine learning models that each shares at least one hyperparameter with the one or more hyperparameters of the machine learning model.

5. The method of claim 4, wherein the one or more previously trained machine learning models are associated with a user of the user device.

6. The method of claim 1, wherein training the unique machine learning model comprises training two or more unique machine learning models in parallel.

7. The method of claim 1, wherein providing the performance of each of the trained unique machine learning models to the user device comprises providing, to the user device, an indication indicating which trained unique machine learning model has the best performance based on the training data.

8 . The method of claim 1, wherein the hyperparameter optimization request comprises a SQL query.

9. The method of claim 1, wherein
the hyperparameter optimization request comprises a budget; and
a size of the set of hyperparameter permutations of the one or more hyperparameters of the machine learning model is based on the budget.

10. The method of claim 1, wherein the data processing hardware is part of a distributed computing database system.

11. The method of claim 1, wherein selecting the one of the trained unique machine learning models comprises:
transmitting the performance of each of the trained unique machine learning models to the user device, and
receiving, from the user device, a trained unique machine learning model selection selecting the one of the trained unique machine learning models.

12. A system comprising:
data processing hardware, and
memory hardware in communication with the data processing hardware, the memory hardware storing instructions that when executed on the data processing
receiving, from a user device, a hyperparameter optimization request requesting optimization of one or more hyperparameters of a machine learning model;
obtaining training data for training the machine learning model,
determining a set of hyperparameter permutations of the one or more hyperparameters of the machine learning model,
for each respective hyperparameter permutation in the set of hyperparameter permutations:
training a unique machine learning model using the training data and the respective hyperparameter permutation;
determining a performance of the trained unique machine learning model;
selecting, based on the performance of each of the trained unique machine learning models, one of the trained unique machine learning models; and
generating one or more predictions using the selected one of the trained unique machine learning models.

13. The system of claim 12, wherein determining the set of hyperparameter permutations comprises performing a search on a hyperparameter search space of the one or more hyperparameters of the machine learning model.

14. The system of claim 13, wherein performing the search on the hyperparameter search space comprises performing the search using a batched Gaussian process bandit optimization.

15. The system of claim 12, wherein determining the set of hyperparameter permutations is based on one or more previously trained machine learning models that each shares at least one hyperparameter with the one or more hyperparameters of the machine learning model.

16. The system of claim 15, wherein the one or more previously trained machine learning models are associated with a user of the user device.

17. The system of claim 12, wherein training the unique machine learning model comprises training two or more of the unique machine learning models in parallel.

18. The system of claim 12, wherein providing the performance of each of the trained unique machine learning models to the user device comprises providing, to the user device, an indication indicating which trained unique machine learning model has the best performance based on the training data.

19. The system of claim 12, wherein the hyperparameter optimization request comprises a SQL query.

20. The system of claim 12, wherein;
the hyperparameter optimization request comprises a budget, and
a size of the set of hyperparameter permutations of the one or more hyperparameters of the machine learning model is based on the budget.

21. The system of claim 12, wherein the data processing hardware is part of a distributed computing database system.

22. The system of claim 12, wherein selecting the one of the trained unique machine learning models comprises:
transmitting the performance of each of the trained unique machine learning models to the user device, and
receiving, from the user device, a trained unique machine learning model selection selecting the one of the trained unique machine learning models.
